(19) United States
(12) Patent Application Publication
(10) Pub. No.: US 2011/0210835 A1
(43) Pub. Date: Sep. 1, 2011

(54) Emergency notification system and method for notifying emergency

(75) Inventor: Hiromasa Kondo, Ichinomiya-city (JP)

(73) Assignee: DENSO CORPORATION, Kariya-city (JP)

(21) Appl. No.: 12/932,522

(22) Filed: Feb. 28, 2011

(30) Foreign Application Priority Data
Mar. 1, 2010 (JP) 2010-044063

(51) Int. Cl. B60Q 1/00

(52) U.S. Cl. 340/425.5

(57) ABSTRACT

An emergency notification system includes: an in-vehicle emergency notification device; and a center device in a service center. The in-vehicle device transmits a preliminary notification signal to the center device when a possibility of collision exists, transmits an emergency notification signal when the vehicle collides, and transmits a cancel signal when the vehicle avoids collision. The center device executes a preliminary notification process for waiting the signals when receiving the preliminary notification signal, executes an emergency notification process when receiving the emergency notification signal, and terminates the preliminary notification process when receiving the cancel signal. The center device determines whether the emergency notification process is necessary when the predetermined time has elapsed without receiving the signals after receiving the preliminary notification signal, executes the emergency notification process when the emergency notification process is necessary, and terminates the preliminary notification process when the emergency notification process is not necessary.

### CROSS REFERENCE TO RELATED APPLICATION

This application is based on Japanese Patent Application No. 2010-44063 filed on Mar. 1, 2010, the disclosure of which is incorporated herein by reference.

### FIELD OF THE INVENTION

The present invention relates to an emergency notification system and a method for notifying emergency. The system includes an in-vehicle emergency notification device for transmitting an emergency notification signal and an information center device for receiving the emergency notification signal and executing an emergency notification process.

### BACKGROUND OF THE INVENTION

In an emergency notification system, an in-vehicle emergency notification device mounted on a vehicle transmits an emergency notification signal via a communication network when an air bag inflates according to collision of the vehicle. The emergency notification signal shows a fact that the collision of the vehicle occurs, i.e., traffic accident occurs. When an information center device mounted in an information center receives the emergency notification signal from the in-vehicle emergency notification device, the information center device executes an emergency notification process for requesting a operator in the center to call an emergency vehicle. This system is disclosed in JP-B2-4245059, which corresponds to U.S. Pat. No. 7,657,374.

Further, in the in-vehicle emergency notification device, even if a signal line such as an air bag signal line and an IG signal line for detecting collision comes down, and/or the emergency notification device is broken according to the collision, the emergency notification is surely performed such that the emergency notification device transmits a preliminary notification signal to the information center via the communication network when a possibility of collision of the vehicle arises. The preliminary notification signal shows the possibility of the collision of the vehicle. Then, the emergency notification device determines for a predetermined time whether the air bag inflates. When the air bag inflates before the predetermined time has elapsed, the emergency notification device transmits the emergency notification signal to the information center via the network. When the air bag does not inflate before the predetermined time has elapsed, the emergency notification device transmits a cancel signal to the information center. This system is disclosed in JP-A-2007-183865.

In the above case, after the information center device receives the preliminary notification signal from the in-vehicle emergency notification device, the information center device executes a preliminary notification process for waiting the emergency notification signal or the cancel signal from the in-vehicle emergency notification device for a predetermined time. When the information center device receives the emergency notification signal from the in-vehicle emergency notification device, the information center device executes the emergency notification process. When the information center device receives the cancel signal from the in-vehicle emergency notification device, the information center device ends the preliminary notification process.

However, after the information center device receives the preliminary notification signal from the in-vehicle emergency notification device, the in-vehicle emergency notification device may be broken so that the in-vehicle emergency notification device cannot transmit both of the emergency notification signal and the cancel signal. Alternatively, even when the in-vehicle emergency notification device transmits the emergency notification signal or the cancel signal, communication failure may occur so that the information center device cannot receive the emergency notification signal or the cancel signal. Thus, the preliminary notification signal from the in-vehicle emergency notification device may be left unsettled. Thus, it is difficult to execute an appropriate process with respect to the preliminary notification signal.

### SUMMARY OF THE INVENTION

In view of the above-described problem, it is an object of the present disclosure to provide an emergency notification system including an in-vehicle emergency notification device for transmitting an emergency notification signal and an information center device for receiving the emergency notification signal and executing an emergency notification process. In the system, even if the information center device does not receive both of the emergency notification signal and a cancel signal from the in-vehicle emergency notification device after the information center device receives a preliminary notification signal from the in-vehicle emergency notification device, the emergency notification system executes an appropriate process with respect to the preliminary notification signal. Further, it is another object of the present disclosure to provide a method for notifying emergency.

According to a first aspect of the present disclosure, an emergency notification system includes: an in-vehicle emergency notification device mounted on a vehicle; and a center device mounted in a service center. The in-vehicle emergency notification device transmits a preliminary notification signal to the center device via a communication network when the in-vehicle emergency notification device determines that a possibility to collide on another vehicle or an obstacle is equal to or higher than a predetermined threshold value. The in-vehicle emergency notification device transmits an emergency notification signal to the center device via the communication network when the in-vehicle emergency notification device determines that the vehicle collides on another vehicle or an obstacle. The in-vehicle emergency notification device transmits a cancel signal to the center device via the communication network when the in-vehicle emergency notification device determines that the vehicle avoids collision after the in-vehicle emergency notification device determines that the possibility to collide on the another vehicle or the obstacle is equal to or higher than the predetermined threshold value. The center device executes a preliminary notification process in such a manner that the center device waits for receiving the emergency notification signal or the cancel signal for a first predetermined time when the center device determines that the center device receives the preliminary notification signal from the in-vehicle emergency notification device. The center device executes an emergency notification process for notifying emergency when the center device determines that the center device receives the emergency notification signal from the in-vehicle emergency notification device. The center device terminates the preliminary notification process when the center device determines that the center device receives the cancel signal from the in-vehicle emergency notification device. The center device determines whether it is necessary to execute the emergency notification process when the center device determines that the first predetermined time has elapsed without receiving the emergency notification signal and the cancel signal after the center device determines that the center device receives the preliminary notification signal from the in-vehicle emergency notification device. The center device executes the emergency notification process when the center device determines that it is necessary to execute the emergency notification process, and the center device terminates the preliminary notification process when the center device determines that it is not necessary to execute the emergency notification process.

In the above system, even when the center device does not receive the emergency notification signal and the cancel signal after the center device receives the preliminary notification signal from the in-vehicle emergency notification device, the center device determines whether it is necessary to execute the emergency notification process. Thus, the center device executes the emergency notification process or terminates the preliminary notification process, so that the preliminary notification signal from the in-vehicle emergency notification device is not left without executing any action. An appropriate action with respect to the preliminary notification signal is executed. Further, the appropriate action with respect to the preliminary notification signal is performed by the center device so that the passenger in the vehicle does not owe the burden of the appropriate action. Convenience and reliance of the system are improved.

According to a second aspect of the present disclosure, a method for notifying emergency from an in-vehicle emergency notification device mounted on a vehicle to a center device mounted in a service center, the method includes: transmitting a preliminary notification signal from the in-vehicle emergency notification device to the center device via a communication network when the in-vehicle emergency notification device determines that a possibility to collide on another vehicle or an obstacle is equal to or higher than a predetermined threshold value; transmitting an emergency notification signal from the in-vehicle emergency notification device transmits to the center device via the communication network when the in-vehicle emergency notification device determines that the vehicle collides on another vehicle or an obstacle; transmitting a cancel signal from the in-vehicle emergency notification device to the center device via the communication network when the in-vehicle emergency notification device determines that the vehicle avoids collision after the in-vehicle emergency notification device determines that the possibility to collide on the another vehicle or the obstacle is equal to or higher than the predetermined threshold value; executing a preliminary notification process in the center device when the center device determines that the center device receives the preliminary notification signal from the in-vehicle emergency notification device, wherein the preliminary notification process includes waiting for receiving the emergency notification signal or the cancel signal by the center device for a first predetermined time; executing an emergency notification process in the center device for notifying emergency when the center device determines that the center device receives the emergency notification signal from the in-vehicle emergency notification device; terminating the preliminary notification process in the center device when the center device determines that the center device receives the cancel signal from the in-vehicle emergency notification device; determining by the center device whether it is necessary to execute the emergency notification process when the center device determines that the first predetermined time has elapsed without receiving the emergency notification signal and the cancel signal after the center device determines that the center device receives the preliminary notification signal from the in-vehicle emergency notification device; executing the emergency notification process in the center device when the center device determines that it is necessary to execute the emergency notification process, and terminating the preliminary notification process in the center device when the center device determines that it is not necessary to execute the emergency notification process.

In the above method, even when the center device does not receive the emergency notification signal and the cancel signal after the center device receives the preliminary notification signal from the in-vehicle emergency notification device, the center device determines whether it is necessary to execute the emergency notification process. Thus, the center device executes the emergency notification process or terminates the preliminary notification process, so that the preliminary notification signal from the in-vehicle emergency notification device is not left without executing any action. An appropriate action with respect to the preliminary notification signal is executed. Further, the appropriate action with respect to the preliminary notification signal is performed by the center device so that the passenger in the vehicle does not owe the burden of the appropriate action. Convenience and reliance of the system are improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing an emergency notification system according to an example embodiment;

FIG. 2 is a flowchart showing a process for determining possibility of collision of a vehicle executed by an in-vehicle emergency notification device;

FIG. 3 is a flowchart showing a process for determining signal receipt executed by an information center device; and

FIG. 4 is a flowchart showing a process for determining collision monitor executed by an information center device.

### DETAILED DESCRIPTION OF THE PREFERRED EMBODIMENTS

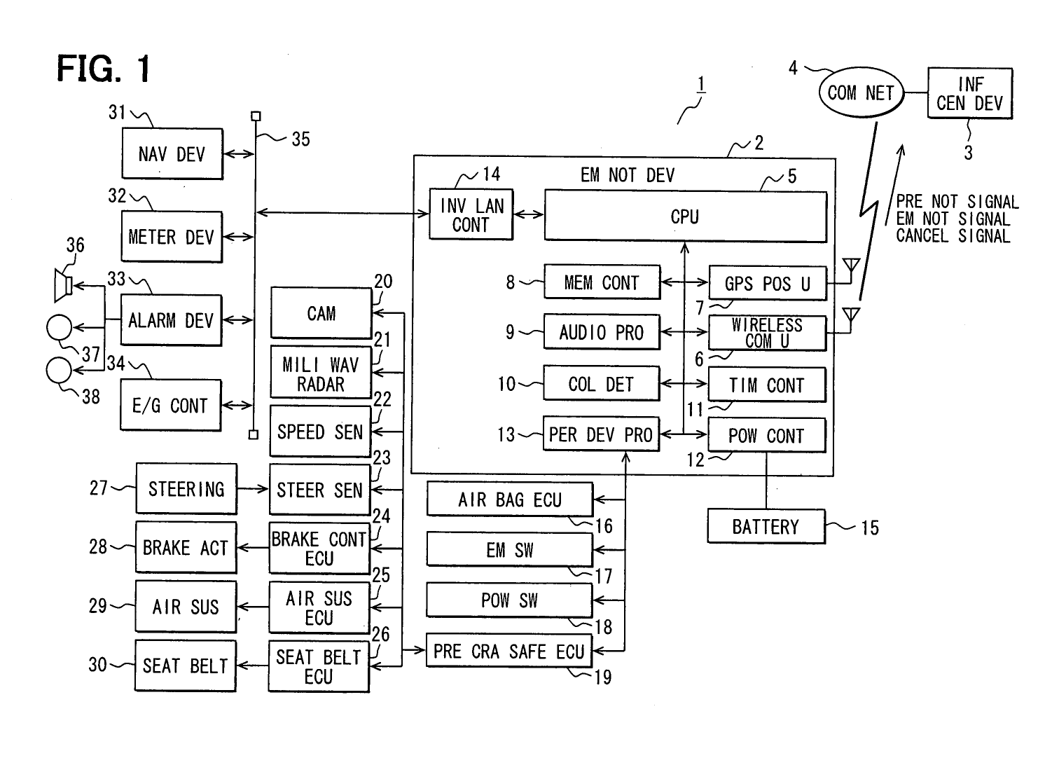

FIG. 1 is a circuit diagram showing a whole construction of an emergency notification system 1 according to an example embodiment. The system 1 includes an in-vehicle emergency notification device 2 mounted on a vehicle and an information center device 3 mounted in an information center. The in-vehicle emergency notification device 2 communicates with the information center device 3 via a communication network 4. The communication network 4 includes a mobile body communication network and/or a fixed communication network.

The in-vehicle emergency notification device 2 includes a CPU 5, a wireless communication unit 6, a GPS positioning unit 7, a memory controller 8, an audio processing unit 9, a collision detector 10, a timer controller 11, a power source controller 12, a peripheral device processing unit 13 and an in-vehicle LAN controller 14. The CPU 5 executes a control program for controlling a whole operation of the in-vehicle emergency notification device 2. The wireless communication unit 6 controls wireless communication with the information center device 3 via the communication network 4. The wireless communication unit 6 switches between voice communication and data communication while the wireless communication unit 6 holds a communication line with the center device 3. Thus, a passenger of the vehicle communicates with an operator of the information center in verbal communication and data communication.

The GPS positioning unit 7 calculates parameters retrieved from a GPS signal so that the GPS positioning unit 7 detects a current position of the vehicle when the GPS positioning unit 7 receives the GPS signal from a GPS satellite. The memory controller 8 controls to store various information. Specifically, the memory controller 8 controls to memorize passenger information (i.e., user information), vehicle information, vehicle position information obtained from the CGPS positioning unit 7 and the like. The audio processing unit 9 processes voice information input from a microphone (not shown), and processes voice information to be output from a speaker (not shown).

The timer controller 11 starts to measure time when the timer controller 11 receives a time measurement starting signal from the CPU 5. After the timer controller 11 measures a predetermined time, i.e., after the predetermined time is up, the timer controller 11 outputs a time measurement ending signal to the CPU 5. The power source controller 12 supplies electricity from the vehicle battery 15 mounted on the vehicle to each function block unit as operation electricity so that the power source controller 12 controls to energize the in-vehicle emergency notification device 2. The peripheral device processing unit 13 is coupled with an air bag ECU 16, a mayday switch 17 (i.e., an emergency switch), a power source switch 18 and a pre-crash safety ECU 19.

The air bag ECU 16 is coupled with an air bag device (not shown). When an ignition, signal output from the power source switch 18 turns on, the air bag ECU 16 functions normally. When the air bag inflates, the air bag ECU 16 outputs an air bag inflation signal. The mayday switch 17 outputs an operation detection signal when the passenger of the vehicle pushes on the mayday switch 17. The power source switch 18 includes an IG switch (ignition switch) and an ACC switch (i.e., accessory switch). The power source switch 18 outputs the IG signal and an ACC signal. The IG signal represents whether the IG switch turns on or off. The ACC signal represents whether the ACC switch turns on or off. The pre-crash safety ECU 19 is coupled with a camera 20, a millimeter wave radar 21, a vehicle speed sensor 22, a steering wheel sensor 23, a brake control ECU 24, an air suspension ECU 25 and a seat belt ECU 26.

The pre crash safety ECU 19 functions normally when the IG signal from the power source switch 18 turns on. For example, the pre crash safety ECU 19 determines based on an image signal input from the camera 20, a radar detection signal input from the millimeter wave radar 21, the vehicle speed signal input from the vehicle speed sensor 22 and a steering wheel signal showing an angle of the steering wheel 27 input from the steering wheel sensor 23 whether possibility of collision of the vehicle on another vehicle and an obstacle is higher than a predetermined value. In this case, when the pre crash safety ECU 19 determines that the possibility of collision is higher than the predetermined value, the pre crash safety ECU 19 outputs a pre crash detection signal.

When the pre crash safety ECU 19 outputs the pre crash detection signal, the pre crash safety ECU 19 controls to function the brake actuator 28 via the brake ECU 25, controls to function the air suspension 29 via the air suspension ECU 26, and controls to wind the seat belt 30 via the seat belt ECU 26 so that impact of the collision is reduced when the vehicle collides on another vehicle or the obstacle. Further, the pre crash safety ECU 19 is coupled with a combination meter (not shown). When the pre crash safety ECU 19 determines that the possibility of the collision exists, the pre crash safety ECU 19 controls the combination meter to display a warning message that shows the possibility of collision.

The in-vehicle LAN controller 14 is coupled with the navigation device 31, the meter device 32, the alarm device 33 and the engine controller 34 via the in-vehicle LAN 35. The in-vehicle LAN controller 14 transmits and receives various signals from each device 31-34, so that the in-vehicle LAN controller 14 controls each device 31-34 to function. Here, the alarm device 33 is coupled with a horn 36, a headlight 37 and the hazard lamp 28.

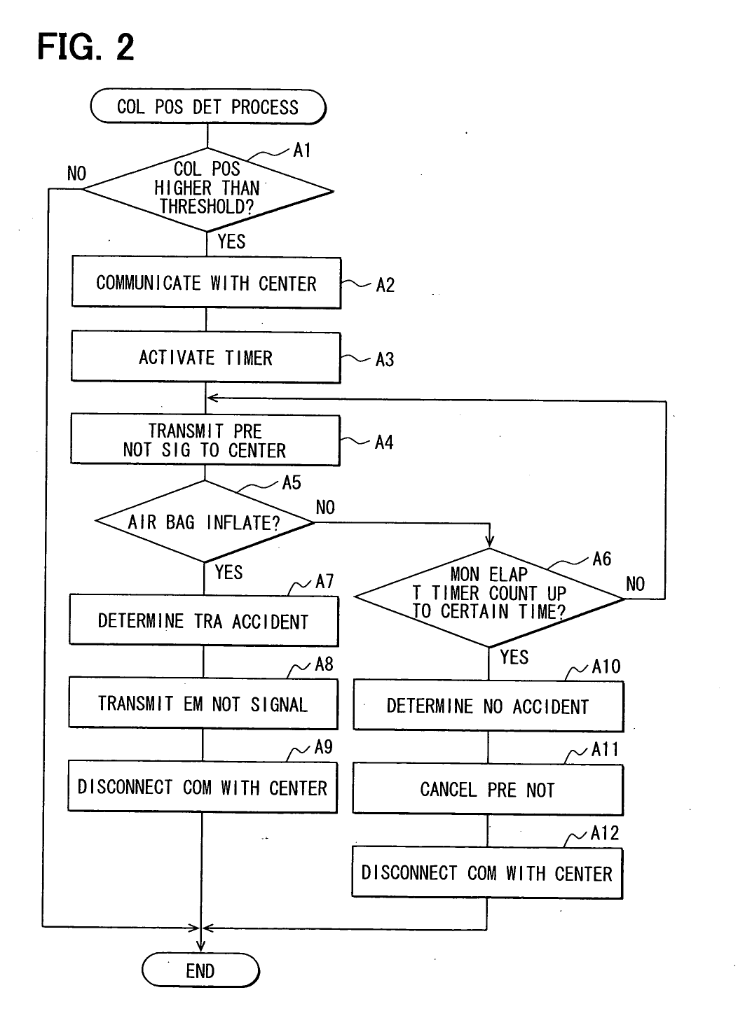

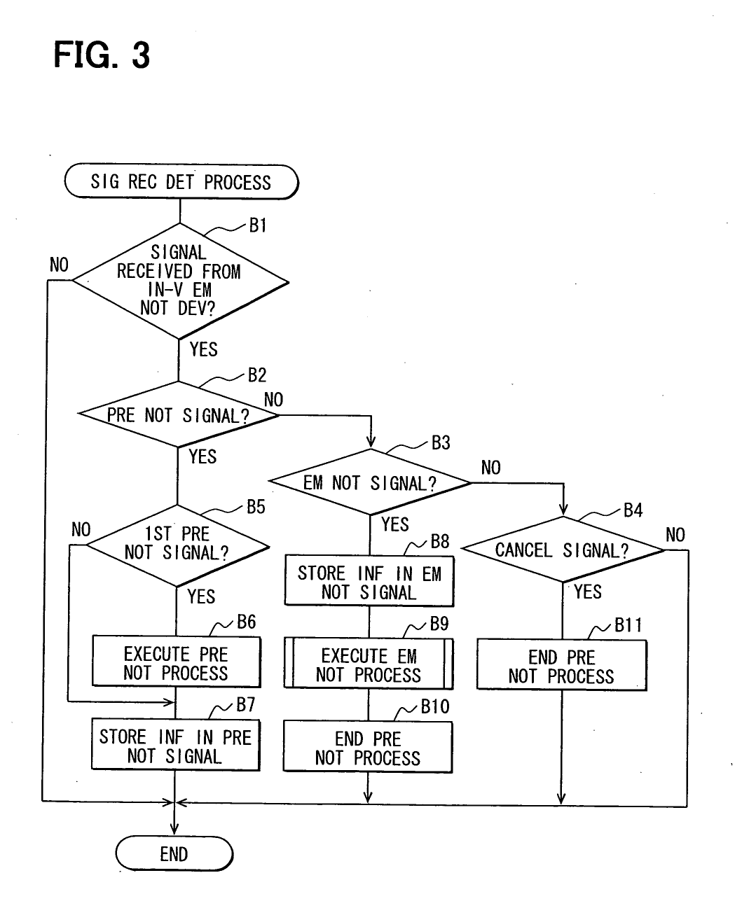

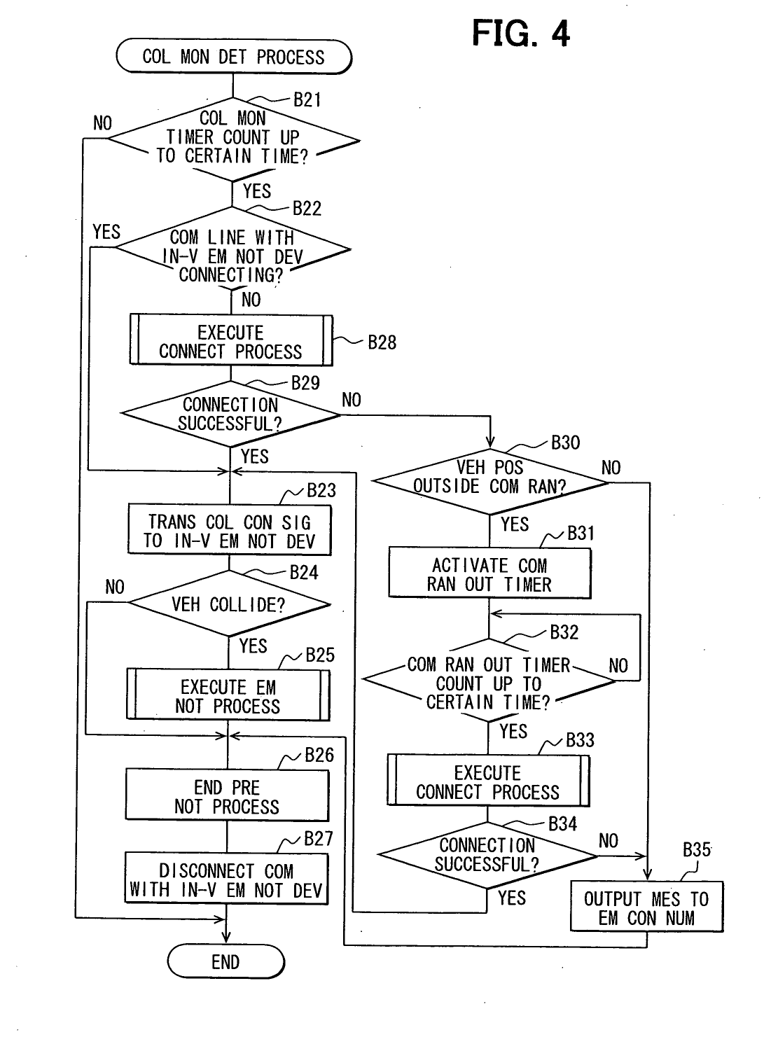

Next, the operation of the above construction will be explained with reference to FIGS. 2 to 4. FIG. 2 is a flowchart of the process for determining possibility of collision of the vehicle executed by the in-vehicle emergency notification device 2. FIG. 3 is a flowchart showing a process for determining signal receipt executed by the information center device 3, and FIG. 4 is a flowchart showing a process for determining collision monitor executed by an information center device 3.

In the in-vehicle emergency notification device 2, the CPU 5 periodically executes the collision possibility determination process at predetermined intervals when the IG signal from the power source switch 18 turns on. When the CPU 5 executes the collision possibility determination process, the CPU 5 determines in step A1 whether the pre crash detection signal from the pre crash safety ECU 19 is input into the CPU 5 via the peripheral device processing unit 13 so that the CPU 5 determines whether there is, a possibility of collision of the vehicle. Specifically, the CPU 5 determines whether the possibility of collision of the vehicle is equal to or higher than a predetermined threshold. When the CPU 5 determines that the pre crash detection signal from the pre crash safety ECU 19 is not input into the CPU 5 so that there is no possibility of collision of the vehicle, i.e., the possibility of collision of the vehicle is lower than the threshold value, i.e., when the determination of step A1 is “NO,” the CPU 5 ends the collision possibility determination process.

When the CPU 5 determines that the pre crash detection signal from the pre crash safety ECU 19 is input into the CPU 5 so that there is a possibility of collision of the vehicle, i.e., the possibility of collision of the vehicle is equal to or higher than the threshold value, i.e., when the determination of step A1 is “YES,” in step A2, the CPU 5 controls to couple between the wireless communication unit 6 and the center device 3 via the communication line 4 under a condition that the preliminary notification is selected, the vehicle speed is equal to or higher than a predetermined speed, and an approach speed of the vehicle approaching another vehicle and/or the obstacle is equal to or larger than a predetermined threshold value.

Next, in step A3, the CPU 5 outputs the time measurement starting signal to the timer controller 11 so that the timer controller 11 activates the timer for, monitoring elapsed time. In step A4, the CPU 5 controls the wireless communication unit 6 to transmit the preliminary notification signal to the center device 3 via the communication network 4. Here, the measurement time of the timer for monitoring elapsed time provides estimated time of collision of the vehicle, which is estimated based on the vehicle speed and the approach speed of the other vehicle and/or the obstacle. The preliminary notification signal transmitted from the in-vehicle emergency notification device 2 to the information center device 3 provides information about passengers in the vehicle, vehicle information, current position information obtained by the GPS positioning unit 7, information of the approach speed of the vehicle approaching the other vehicles and the obstacle, which may collide with the vehicle, information about electric wave conditions and steering wheel information.

In step A5, the CPU 5 determines whether the air bag inflation signal is input into the CPU 5 from the air bag ECU 16 via the peripheral device processing unit 13. Further, in step A6, the CPU 5 determines whether the time measurement ending signal is input into the CPU 5 from the timer controller 11. Specifically, in step A6, the CPU 5 determines whether the measurement time of the timer is up. Here, when the CPU 5 determines that the air bag inflation signal is input into the CPU 5 from the air bag ECU 16 before the time measurement ending signal is input into the CPU 5 from the timer controller 11 so that the air bag inflates, i.e., when the determination of step A5 is “YES,” in step A7, the CPU 5 specifies that the traffic accident occurs. Then, in step A8, the CPU 5 controls the wireless communication unit 6 to transmit the emergency notification signal to the center device 3 via the communication network 4 so that the emergency notification is performed. The emergency notification signal transmitted from the in-vehicle emergency notification device 2 to the center device 3 provides information about the passenger in the vehicle, vehicle information, and the current position of the vehicle obtained from the GPS positioning unit 7. In step A9, the CPU 5 disconnects the communication line between the wireless communication unit 6 and the center device 3 when the emergency notification ends. The CPU 5 ends the collision possibility determination process.

When, the CPU 5 determines that the time measurement ending signal is input into the CPU 5 from the timer controller 11 before the air bag inflation signal is input from the air bag ECU 16, i.e., when the determination in step A6 is “YES,” the CPU 5 specifies that there is no traffic accident in step A10, i.e., the CPU 5 determines that the collision is avoided. Then, the CPU 5 transmits the cancel signal to the center device 3 via the wireless communication unit 6 and the communication network 4. In step A11, the CPU 5 cancels the preliminary notification. Then, the CPU 5 disconnects the communication line between the wireless communication unit 6 and the center device 3 in step A12. Then, the CPU 5 ends the collision possibility determination process.

Thus, the in-vehicle emergency notification device 2 transmits one of the emergency notification signal and the cancel signal from the wireless communication unit 6 to the center device 3 via the communication network 4 after the device 2 determines that the possibility of collision of the vehicle exists, and the device 2 transmits the preliminary notification signal from the wireless communication unit 6 to the center device 3 via the communication network 4 as long as the device 2 functions normally, i.e., as long as the device 2 is not broken and capable of transmitting a signal.

The center device 3 periodically executes the signal receipt determination process and the collision monitor determination process at predetermined intervals when the center device 3 turns on. When the center device 3 starts to execute the signal receipt determination process, in step B1, the center device 3 determines whether the device 3 receives a signal from the in-vehicle emergency notification device 2 via the network 4. Here, when the center device 3 determines that the device 3 does not receive the signal from the in-vehicle emergency notification device 2 via the network 4, i.e., when the determination in step B1 is “NO,” the device 3 ends the signal receipt determination process.

When the center device 3 determines that the device 3 receives the signal from the in-vehicle emergency notification device 2 via the network 4, i.e., when the determination in step B1 is “YES,” the center device 3 determines whether the received signal is the preliminary notification signal, the emergency notification signal or the cancel signal in steps B2-B4. When the center device 3 determines that the received signal is the preliminary notification signal, i.e., when the determination in step B2 is “YES,” the device 3 determines whether the received preliminary notification signal is the first preliminary notification signal in step B5. When the device 3 determines that the received preliminary notification signal is the first preliminary notification signal, i.e., when the determination of step B5 is “YES,” the device 3 starts to execute the preliminary notification process and activates the collision monitor timer in step B6. In the preliminary notification process, the device 3 waits the receipt of the emergency notification signal or the cancel signal. The measurement time of the collision monitor timer has the same characteristics as the measurement time of the elapsed time monitor timer. The measurement time of the collision monitor timer provides estimated time of occurrence of collision, which is estimated according to the vehicle speed and the approach speed of the other vehicles and the obstacle.

The center device 3 stores information in the received preliminary notification signal in step B7. Then, the device 3 ends the signal receipt determination process. When the center device 3 determines that the preliminary notification signal is not the first preliminary notification signal, i.e., when the determination of step B5 is “NO,” the device 3 stores information in the preliminary notification signal in step B7 since the device 3 execute the preliminary notification process already at that time. Then, the device 3 ends the signal receipt determination process.

When the center device 3 determines that the received signal is the emergency notification signal, i.e., when the determination in step B3 is “YES,” the device 3 stores the information in the emergency notification signal in step B8. Then, in step B9, device 3 executes the emergency notification process. Specifically, the center device 3 connects to the in-vehicle emergency notification device 2 via a verbal communication line so that the passenger in the vehicle can communicates with the operator in the center with verbal communication. Specifically, the passenger in the vehicle can request the relief, or explain the situation of damage. Then, the operator consider the relief request and situation of traffic accident reported from the passenger, and based on these facts, the operator can arrange to call an ambulance. When the emergency notification process ends, the center device 3 ends the preliminary notification process, which has been executed prior to the emergency notification process. Specifically, the device 3 cancels the preliminary notification process. Further, the device 3 stops to operate the collision monitor timer in step B10 since the collision monitor timer has functioned prior to the emergency notification process. Then, the device 3 ends the signal receipt determination process.

When the device 3 determines that the received signal is the cancel signal, i.e., when the determination in step B4 is “YES,” the device 3 ends the preliminary notification process, which has been executed before, without performing the emergency notification process. Further, the device 3 stops operating the collision monitor timer, which has been activated before. Then, the device 3 ends the signal receipt determination process.

Thus, after the center device 3 receives the preliminary notification signal transmitted from the in-vehicle emergency notification device 2 via the communication network 4, the center device 3 receives the emergency notification signal or the cancel signal transmitted from the in-vehicle emergency notification device 2 via the network 4 as long as the in-vehicle emergency notification device 2 functions normally, and the network 4 functions normally, i.e., communication failure does not occur. When the center device 3 receives the emergency notification signal, the center device 3 ends the preliminary notification process after the center device 3 executes the emergency notification process. On the other hand, when the center device 3 receives the cancel signal, the center device 3 ends the preliminary notification process without executing the emergency notification process.

As described above, the preliminary notification signal is transmitted from the in-vehicle emergency notification device 2. After the center device 3 receives the preliminary notification signal via the network 4, as long as the in-vehicle emergency notification device 2 functions normally, and the network 4 functions normally, i.e., communication failure does not occur, the in-vehicle emergency notification device 2 transmits the emergency notification signal or the cancel signal. The center device 3 receives the emergency notification signal or the cancel signal via the network 4. When the in-vehicle emergency notification device 2 cannot transmit a signal, or the communication failure occurs, the in-vehicle emergency notification device 2 may not transmit both of the emergency notification signal and the cancel signal. Even if the in-vehicle emergency notification device 2 transmits the emergency notification signal or the cancel signal, the center device 3 may not receive the emergency notification signal and the cancel signal via the network 4. In the present embodiment, in view of these points, the center device 3 executes a collision monitor determination process.

When the center device 3 starts to execute the collision monitor determination process, in step B21 of FIG. 4, the device 3 determines whether the collision monitor timer activated according to the first preliminary notification signal received by the device 3 counts that time is up without receiving the emergency notification signal and the cancel signal from the in-vehicle emergency notification device 2. Here, when the center device 3 determines that the time is not up in the collision monitor timer, i.e., when the determination of step B21 is “NO,” the center device 3 ends the collision monitor determination process.

When the center device 3 determines that the time is up in the collision monitor timer without receiving the emergency notification signal and the cancel signal from the in-vehicle emergency notification device 2. i.e., when the determination of step B21 is “YES,” the center device 3 determines in step B22 whether the center device 3 is connecting to the in-vehicle emergency notification device 2 with the communication line. When the center device 3 determines that the center device 3 is connecting to the in-vehicle emergency notification device 2 with the communication line, i.e., when the determination of step B22 is “YES,” the center device 3 transmits the collision confirmation signal to the in-vehicle emergency notification device 2 in step B23. Here, the collision confirmation signal provides information about the output status of the air bag inflation signal, the output status of the IG signal, the vehicle speed, the current position of the vehicle and the like.

In the in-vehicle emergency notification device 2, when the CPU 5 determines that the wireless communication unit 6 functions normally, and the wireless communication unit 6 receives the collision confirmation signal from the center device 3, the in-vehicle emergency notification device 2 transmits a response signal of the collision confirmation signal to the center device 3 via the wireless communication unit 6. On the other hand, when the wireless communication unit 6 does not function normally so that the wireless communication unit 6 does not receive the collision confirmation signal from the center device 3, or the wireless communication unit 6 does not transmit the response signal of the collision confirmation signal, the in-vehicle emergency notification device 2 does not output the response signal of the collision confirmation signal to the center device 3.

The center device 3 determines in step B24 whether a response status with respect to the collision confirmation signal from the in-vehicle emergency notification device 2 so that the device 3 determines whether the vehicle may collide with another vehicle or an obstacle. Specifically, the center device 3 determines that the collision response signal represents an abnormality when the center device 3 receives the collision response signal from the in-vehicle emergency notification device 2 via the network 4. Alternatively, the device 3 determines that the center device 3 does not receive the collision response signal from in-vehicle emergency notification device 2. In these cases, the center device 3 determines that the vehicle may collide with another vehicle or an obstacle, i.e. when the determination of step B24 is “YES,” similar to step B9, the center device 3 executes the emergency notification process in step B25. Here, in this case, the center device 3 may determine based on logical comparison whether the vehicle may collide with another vehicle or an obstacle. The logical comparison is performed such that the device 3 compares a certain value with a threshold value. Alternatively, or additionally, the center device 3 may determine based on an operator's decision in the information center whether the vehicle may collide with another vehicle or an obstacle. The operator's decision is performed such that the operator in the center considers the report from the passenger in the vehicle, and then, the operator determines whether the vehicle may collide with another vehicle or an obstacle.

When the center device 3 ends the emergency notification process, the center device 3 also ends the preliminary notification process, which has been previously executed prior to the emergency notification process. Further, the device 3 stops to operate the collision monitor timer in step B26. The collision monitor timer has been activated prior to the emergency notification process. Further, the device 3 disconnects the communication line with the in-vehicle emergency notification device 2 in step B27. Then, the device 3 ends the collision monitor determination process.

When the center device 3 determines in step B22 that that the center device 3 is not connecting to the in-vehicle emergency notification device 2 with the communication line, i.e., when the determination of step B22 is “NO,” the center device 3 executes a connection process in step B28 so that the device 3 connects the communication line to the in-vehicle emergency notification device 2. Then, the device 3 determines in step B29 whether the connection of the communication line to the in-vehicle emergency notification device 2 is successful. When the device 3 determines that the connection of the communication line to the in-vehicle emergency notification device 2 is successful, i.e., when the determination of step B29 is “YES,” the device 3 executes steps B23 to B27.

When the device 3 determines that the connection of the communication line to the in-vehicle emergency notification device 2 is not successful, i.e., when the determination of step B29 is “NO,” the device 3 determines in step B30 whether a current position of the vehicle is disposed outside a communication range. In this case, the center device 3 determines whether a current position of the vehicle is disposed outside a communication range in such a manner that the device 3 determines whether an electric field intensity of reception of the preliminary notification signal is smaller than a threshold value, the device 3 compares the current position described in the preliminary notification signal with the map stored in the information center whether the current position of the vehicle is disposed outside the communication range, or the device 3 determines based on a track record of the position of the vehicle and steering angle information whether the current position of the vehicle id disposed outside the communication range. Here, the map stored in the information center shows the communication range and the outside of the communication range. The track record of the position of the vehicle is periodically transmitted from the in-vehicle emergency notification device 2 to the center device 3.

When the center device 3 determines in step B30 that the current position of the vehicle is disposed outside the communication range, i.e., when the determination of step B30 is “YES,” the device 3 activates the communication-range-outside passing through timer in step B31. The communication-range-outside passing through timer counts time up to a certain time, which is estimated time for the vehicle passing through the outside of the communication range. The vehicle passes through the outside of the communication range and reaches the communication range within the certain time. Thus, in step B32, the device 3 stands by until time counted by the communication-range-outside passing through timer is up. Then, when the center device 3 determines that the time counted by the communication-range-outside passing through timer is up, i.e., when the determination of step B32 is “YES,” the center device 3 executes a connection process in step B33 so that the device 3 connects the communication line to the in-vehicle emergency notification device 2. Then, the device 3 determines in step B34 whether the connection of the communication line to the in-vehicle emergency notification device 2 is successful. When the device 3 determines that the connection of the communication line to the in-vehicle emergency, notification device 2 is successful, i.e., when the determination of step B34 is “YES,” the device 3 executes steps B23 to B27.

When the center device 3 determines in step B30 that the current position of the vehicle is not disposed outside the communication range (i.e., the current position of the vehicle is disposed in the communication range), i.e., when the determination of step B30 is “NO,” it goes to step B35. Further, when the center device 3 determines in step B34 that the connection of the communication line to the in-vehicle emergency notification device 2 is not successful, i.e., when the determination of step B34 is “NO,” it goes to step B35. In step B35, the device 3 outputs a voice message to a preliminary registered emergency contact number. Then, the device 3 executes steps B26 and B27. Here, the preliminary registered emergency contact number is, for example, a telephone number of a cell phone, which the passenger carries, a telephone number of a cell phone, which an acquaintance or a family member carries, and/or a home telephone number.

In the present embodiment, when the center device 3 receives the preliminary notification signal from the in-vehicle emergency notification device 2, the center device 3 executes the preliminary notification process for waiting the reception of the emergency notification signal or the cancel signal from the in-vehicle emergency notification device 2. Further, the device 3 activates the elapsed time monitor timer. When the device 3 determines that the time counted by the elapsed time monitor timer is up without receiving the emergency notification signal and the cancel signal, the device 3 determines whether it is necessary to execute the emergency notification process. When the device 3 determines that it is necessary to execute the emergency notification process, the device 3 ends the preliminary notification process after the device 3 executes the emergency notification process. When the device 3 determines that it is not necessary to execute the emergency notification process, the device 3 ends the preliminary notification process without executing the emergency notification process. Thus, the preliminary notification signal from the in-vehicle emergency notification device 2 is appropriately handled, and therefore, the preliminary notification signal is not left. Thus, when the center device 3 processes the preliminary notification signal from the in-vehicle emergency notification device 2, the preliminary notification signal is appropriately handled without burden of the passenger. Convenience of the system is improved.

The in-vehicle emergency notification device 2 may be a single device. Alternatively, the in-vehicle emergency notification device 2 may be a part of a module, which is preliminary mounted on the vehicle. Alternatively, a part of the in-vehicle emergency notification device 2 may be provided by a navigation system.

In the present embodiment, when the air bag inflation signal is outputs from the air bag system, the in-vehicle emergency notification device 2 transmits the emergency notification signal. Alternatively, when the user operates a mayday switch as an emergency switch, the mayday switch may output an operation signal and the in-vehicle emergency notification device 2 may transmit the emergency notification signal. Alternatively, when another system functions, the in-vehicle emergency notification device 2 may transmit the emergency notification signal.

The above disclosure has the following aspects.

According to a first aspect of the present disclosure, an emergency notification system includes: an in-vehicle emergency notification device mounted on a vehicle; and a center device mounted in a service center. The in-vehicle emergency notification device transmits a preliminary notification signal to the center device via a communication network when the in-vehicle emergency notification device determines that a possibility to collide on another vehicle or an obstacle is equal to or higher than a predetermined threshold value. The in-vehicle emergency notification device transmits an emergency notification signal to the center device via the communication network when the in-vehicle emergency notification device determines that the vehicle collides on another vehicle or an obstacle. The in-vehicle emergency notification device transmits a cancel signal to the center device via the communication network when the in-vehicle emergency notification device determines that the vehicle avoids collision after the in-vehicle emergency notification device determines that the possibility to collide on the another vehicle or the obstacle is equal to or higher than the predetermined threshold value. The center device executes a preliminary notification process in such a manner that the center device waits for receiving the emergency notification signal or the cancel signal for a first predetermined time when the center device determines that the center device receives the preliminary notification signal from the in-vehicle emergency notification device. The center device executes an emergency notification process for notifying emergency when the center device determines that the center device receives the emergency notification signal from the in-vehicle emergency notification device. The center device terminates the preliminary notification process when the center device determines that the center device receives the cancel signal from the in-vehicle emergency notification device. The center device determines whether it is necessary to execute the emergency notification process when the center device determines that the first predetermined time has elapsed without receiving the emergency notification signal and the cancel signal after the center device determines that the center device receives the preliminary notification signal from the in-vehicle emergency notification device. The center device executes the emergency notification process when the center device determines that it is necessary to execute the emergency notification process, and the center device terminates the preliminary notification process when the center device determines that it is not necessary to execute the emergency notification process.

In the above system, even when the center device does not receive the emergency notification signal and the cancel signal after the center device receives the preliminary notification signal from the in-vehicle emergency notification device, the center device determines whether it is necessary to execute the emergency notification process. Thus, the center device executes the emergency notification process or terminates the preliminary notification process, so that the preliminary notification signal from the in-vehicle emergency notification device is not left without executing any action. An appropriate action with respect to the preliminary notification signal is executed. Further, the appropriate action with respect to the preliminary notification signal is performed by the center device so that the passenger in the vehicle does not owe the burden of the appropriate action. Convenience and reliance of the system are improved.

Alternatively, the center device may determine whether it is necessary to execute the emergency notification process in such a manner that the center device transmits a collision confirmation signal to the in-vehicle emergency notification device via the communication network, and the center device judges a response status with respect to the collision confirmation signal from the in-vehicle emergency notification device.

Alternatively, the center device may judge the response status with respect to the collision confirmation signal in such a manner that the center device judges a connection status of a communication line to the in-vehicle emergency notification device, the center device tries to connect the communication line to the in-vehicle emergency notification device when the center device determines that the communication line to the in-vehicle emergency notification device is disconnected, the center device transmits the collision confirmation signal to the in-vehicle emergency notification device via the communication network when the center device determines that the communication line to the in-vehicle emergency notification device is connected, and the center device judges a response signal from the in-vehicle emergency notification device with respect to the collision confirmation signal. In this case, even when the communication line between the center device and the in-vehicle emergency notification device is disconnected, the center device starts to connect to the in-vehicle emergency notification device via the communication line. When the center device determines that the communication line to the in-vehicle emergency notification device is connected, the center device transmits the collision confirmation signal to the in-vehicle emergency notification device via the communication network. Further, the center device judges a response signal from the in-vehicle emergency notification device with respect to the collision confirmation signal. Thus, the center device determines whether it is necessary to execute the emergency notification process.

Alternatively, the center device may communicate with a preliminary registered emergency contact place when the center device fails to connect to the in-vehicle emergency notification device after the center device tries to connect the communication line to the in-vehicle emergency notification device in a case where the center device determines that the communication line to the in-vehicle emergency notification device is disconnected.

Alternatively, the center device may judge the response status with respect to the collision confirmation signal in such a manner that the center device judges whether the vehicle is disposed in a communication range of the communication network, the center device tries to connect the communication line to the in-vehicle emergency notification device after a second predetermined time has elapsed when the center device determines that the vehicle is disposed outside the communication range of the communication network, the center device transmits the collision confirmation signal to the in-vehicle emergency notification device via the communication network when the center device determines that the communication line to the in-vehicle emergency notification device is connected, and the center device judges a response signal from the in-vehicle emergency notification device with respect to the collision confirmation signal. The second predetermined time is an estimated time, in which the vehicle moves from the outside of the communication range to an inside of the communication range.

Alternatively, the center device may communicate with a preliminary registered emergency contact place when the center device fails to connect to the in-vehicle emergency notification device after the center device tries to connect the communication line to the in-vehicle emergency notification device in a case where the second predetermined time has elapsed since the center device determines that the vehicle is disposed outside the communication range of the communication network.

Alternatively, the center device may communicate with a preliminary registered emergency contact place when the center device determines that the vehicle is disposed outside the communication range of the communication network.

According to a second aspect of the present disclosure, a method for notifying emergency from an in-vehicle emergency notification device mounted on a vehicle to a center device mounted in a service center, the method includes: transmitting a preliminary notification signal from the in-vehicle emergency notification device to the center device via a communication network when the in-vehicle emergency notification device determines that a possibility to collide on another vehicle or an obstacle is equal to or higher than a predetermined threshold value; transmitting an emergency notification signal from the in-vehicle emergency notification device transmits to the center device via the communication network when the in-vehicle emergency notification device determines that the vehicle collides on another vehicle or an obstacle; transmitting a cancel signal from the in-vehicle emergency notification device to the center, device via the communication network when the in-vehicle emergency notification device determines that the vehicle avoids collision after the in-vehicle emergency notification device determines that the possibility to collide on the another vehicle or the obstacle is equal to or higher than the predetermined threshold value; executing a preliminary notification process in the center device when the center device determines that the center device receives the preliminary notification signal from the in-vehicle emergency notification device, wherein the preliminary notification process includes waiting for receiving the emergency notification signal or the cancel signal by the center device for a first predetermined time; executing an emergency notification process in the center device for notifying emergency when the center device determines that the center device receives the emergency notification signal from the in-vehicle emergency notification device; terminating the preliminary notification process in the center device when the center device determines that the center device receives the cancel signal from the in-vehicle emergency notification device; determining by the center device whether it is necessary to execute the emergency notification process when the center device determines that the first predetermined time has elapsed without receiving the emergency notification signal and the cancel signal after the center device determines that the center device receives the preliminary notification signal from the in-vehicle emergency notification device; executing the emergency notification process in the center device when the center device determines that it is necessary to execute the emergency notification process, and terminating the preliminary notification process in the center device when the center device determines that it is not necessary to execute the emergency notification process.

In the above method, even when the center device does not receive the emergency notification signal and the cancel signal after the center device receives the preliminary notification signal from the in-vehicle emergency notification device, the center device determines whether it is necessary to execute the emergency notification process. Thus, the center device executes the emergency notification process or terminates the preliminary notification process, so that the preliminary notification signal from the in-vehicle emergency notification device is not left without executing any action. An appropriate action with respect to the preliminary notification signal is executed. Further, the appropriate action with respect to the preliminary notification signal is performed by the center device so that the passenger in the vehicle does not owe the burden of the appropriate action. Convenience and reliance of the system are improved.

Alternatively, the determining by the center device whether it is necessary to execute the emergency notification process may include: transmitting a collision confirmation signal from the center device to the in-vehicle emergency notification device via the communication network; and judging, by the center device, a response status with respect to the collision confirmation signal from the in-vehicle emergency notification device.

Alternatively, the judging the response status by the center device may include: judging, by the center device, a connection status of a communication line to the in-vehicle emergency notification device; trying by the center device to connect the communication line to the in-vehicle emergency notification device when the center device determines that the communication line to the in-vehicle emergency notification device is disconnected; transmitting the collision confirmation signal from the center device to the in-vehicle emergency notification device via the communication network when the center device determines that the communication line to the in-vehicle emergency notification device is connected; and judging, by the center device, a response signal from the in-vehicle emergency notification device with respect to the collision confirmation signal.

Alternatively, the executing the emergency notification process may include communicating, by the center device, with a preliminary registered emergency contact place when the center device fails to connect to the in-vehicle emergency notification device after the center device tries to connect the communication line to the in-vehicle emergency notification device in a case where the center device determines that the communication line to the in-vehicle emergency notification device is disconnected.

Alternatively, the judging the response status by the center device may include: judging by the center device whether the vehicle is disposed in a communication range of the communication network; trying by the center device to connect the communication line to the in-vehicle emergency notification device after a second predetermined time has elapsed when the center device determines that the vehicle is disposed outside the communication range of the communication network; transmitting the collision confirmation signal from the center device to the in-vehicle emergency notification device via the communication network when the center device determines that the communication line to the in-vehicle emergency notification device is connected; and judging, by the center device, a response signal from the in-vehicle emergency notification device with respect to the collision confirmation signal. The second predetermined time is an estimated time, in which the vehicle moves from the outside of the communication range to an inside of the communication range.

Alternatively, the executing the emergency notification process may include communicating by the center device with a preliminary registered emergency contact place when the center device fails to connect to the in-vehicle emergency notification device after the center device tries to connect the communication line to the in-vehicle emergency notification device in a case where the second predetermined time has elapsed since the center device determines that the vehicle is disposed outside the communication range of the communication network.

Alternatively, the executing the emergency notification process may include communicating by the center device with a preliminary registered emergency contact place when the center device determines that the vehicle is disposed outside the communication range of the communication network.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations; including more, less or only a single element, are also within the spirit and scope of the invention.

What is claimed is:

1. An emergency notification system comprising:
an in-vehicle emergency notification device mounted on a vehicle; and
a center device mounted in a service center,
wherein the in-vehicle emergency notification device transmits a preliminary notification signal to the center device via a communication network when the in-vehicle emergency notification device determines that a possibility to collide on another vehicle or an obstacle is equal to or higher than a predetermined threshold value,
wherein the in-vehicle emergency notification device transmits an emergency notification signal to the center device via the communication network when the in-vehicle emergency notification device determines that the vehicle collides on another vehicle or an obstacle,
wherein the in-vehicle emergency notification device transmits a cancel signal to the center device via the communication network when the in-vehicle emergency notification device determines that the vehicle avoids collision after the in-vehicle emergency notification device determines that the possibility to collide on the another vehicle or the obstacle is equal to or higher than the predetermined threshold value,
wherein the center device executes a preliminary notification process in such a manner that the center device waits for receiving the emergency notification signal or the cancel signal for a first predetermined time when the center device determines that the center device receives the preliminary notification signal from the in-vehicle emergencynotification device,
wherein the center device executes an emergency notification process for notifying emergency when, the center device determines that the center device receives the emergency notification signal from the in-vehicle emergency notification device,
wherein the center device terminates the preliminary notification process when the center device determines that the center device receives the cancel signal from the in-vehicle emergency notification device,
wherein the center device determines whether it is necessary to execute the emergency notification process when the center device determines that the first predetermined time has elapsed without receiving the emergency notification signal and the cancel signal after the center device determines that the center device receives the preliminary notification signal from the in-vehicle emergency notification device,
wherein the center device executes the emergency notification process when the center device determines that it is necessary to execute the emergency notification process, and
wherein the center device terminates the preliminary notification process When the center device determines that it is not necessary to execute the emergency notification process.

2. The emergency notification system according to claim 1,
wherein the center device determines whether it is necessary to execute the emergency notification process in such a manner that the center device transmits a collision confirmation signal to the in-vehicle emergency notification device via the communication network, and the center device judges a response status with respect to the collision confirmation signal from the in-vehicle emergency notification device.

3. The emergency notification system according to claim 2,
wherein the center device judges the response status with respect to the collision confirmation signal in such a manner that the center device judges a connection status of a communication line to the in-vehicle emergency notification device, the center device tries to connect the communication line to the in-vehicle emergency notification device when the center device determines that the communication line to the in-vehicle emergency notification device is disconnected, the center device transmits the collision confirmation signal to the in-vehicle emergency notification device via the communication network when the center device determines that the communication line to the in-vehicle emergency notification device is connected, and the center device judges a response signal from the in-vehicle emergency notification device with respect to the collision confirmation signal.

4. The emergency notification system according to claim 3,
wherein the center device communicates with a preliminary registered emergency contact place when the center device fails to connect to the in-vehicle emergency notification device after the center device tries to connect the communication line to the in-vehicle emergency notification device in a case where the center device determines that the communication line to the in-vehicle emergency notification device is disconnected.

5. The emergency notification system according to claim 2,
wherein the center device judges the response status with respect to the collision confirmation signal in such a manner that the center device judges whether the vehicle is disposed in a communication range of the communication network, the center device tries to connect the communication line to the in-vehicle emergency notification device after a second predetermined time has elapsed when the center device determines that the vehicle is disposed outside the communication range of the communication network, the center device transmits the collision confirmation signal to the in-vehicle emergency notification device via the communication network when the center device determines that the communication line to the in-vehicle emergency notification device is connected, and the center device judges a response signal from the in-vehicle emergency notification device with respect to the collision confirmation signal, and
wherein the second predetermined time is an estimated time, in which the vehicle moves from the outside of the communication range to an inside of the communication range.

6. The emergency notification system according to claim 5,
wherein the center device communicates with a preliminary registered emergency contact place when the center device fails to connect to the in-vehicle emergency notification device after the center device tries to connect the communication line to the in-vehicle emergency notification device in a case where the second predetermined time has elapsed since the center device determines that the vehicle is disposed outside the communication range of the communication network.

7. The emergency notification system according to claim 5,
wherein the center device communicates with a preliminary registered emergency contact place when the center device determines that the vehicle is disposed outside the communication range of the communication network.

8. A method for notifying emergency from an in-vehicle emergency notification device mounted on a vehicle to a center device mounted in a service center, the method comprising:
transmitting a preliminary notification signal from the in-vehicle emergency notification device to the center device via a communication network when the in-vehicle emergency notification device determines that a possibility to collide on another vehicle or an obstacle is equal to or higher than a predetermined threshold value;
transmitting an emergency notification signal from the in-vehicle emergency notification device transmits to the center device via the communication network when the in-vehicle emergency notification device determines that the vehicle collides on another vehicle or an obstacle;
transmitting a cancel signal from the in-vehicle emergency notification device to the center device via the communication network when the in-vehicle emergency notification device determines that the vehicle avoids collision after the in-vehicle emergency notification device determines that the possibility to collide on the another vehicle or the obstacle is equal to or higher than the predetermined threshold value;
executing a preliminary notification process in the center device when the center device determines that the center device receives the preliminary notification signal from the in-vehicle emergency notification device, wherein the preliminary notification process includes waiting for receiving the emergency notification signal or the cancel signal by the center device for a first predetermined time;
executing an emergency notification process in the center device for notifying emergency when the center device determines that the center device receives the emergency notification signal from the in-vehicle emergency notification device;
terminating the preliminary notification process in the center device when the center device determines that the center device receives the cancel signal from the in-vehicle emergency notification device;
determining by the center device whether it is necessary to execute the emergency notification process when the center device determines that the first predetermined time has elapsed without receiving the emergency notification signal and the cancel signal after the center device determines that the center device receives the preliminary notification signal from the in-vehicle emergency notification device;
executing the emergency notification process in the center device when the center device determines that it is necessary to execute the emergency notification process, and
terminating the preliminary notification process in the center device when the center device determines that it is not necessary to execute the emergency notification process.

9. The method according to claim 8,
wherein the determining by the center device whether it is necessary to execute the emergency notification process includes:
transmitting a collision confirmation signal from the center device to the in-vehicle emergency notification device via the communication network; and
judging, by the center device, a response status with respect to the collision confirmation signal from the in-vehicle emergency notification device.

10. The method according to claim 9,
wherein the judging the response status by the center device includes:
judging, by the center device, a connection status of a communication line to the in-vehicle emergency notification device;
trying by the center device to connect the communication line to the in-vehicle emergency notification device when the center device determines that the communication line to the in-vehicle emergency notification device is disconnected;
transmitting the collision confirmation signal from the center device to the in-vehicle emergency notification device via the communication network when the center device determines that the communication line to the in-vehicle emergency notification device is connected; and
judging, by the center device, a response signal from the in-vehicle emergency notification device with respect to the collision confirmation signal.

11. The method according to claim 10,
wherein the executing the emergency notification process includes communicating, by the center device, with a preliminary registered emergency contact place when the center device fails to connect to the in-vehicle emergency notification device after the center device tries to connect the communication line to the in-vehicle emergency notification device in a case where the center device determines that the communication line to the in-vehicle emergency notification device is disconnected.

12. The method according to claim 9,
wherein the judging the response status by the center device includes:
judging by the center device whether the vehicle is disposed in a communication range of the communication network;
trying by the center device to connect the communication line to the in-vehicle emergency notification device after a second predetermined time has elapsed when the center device determines that the vehicle is disposed outside the communication range of the communication network;
transmitting the collision confirmation signal from the center device to the in-vehicle emergency notification device via the communication network when the center device determines that the communication line to the in-vehicle emergency notification device is connected; and
judging, by the center device, a response signal from the in-vehicle emergency notification device with respect to the collision confirmation signal, and
wherein the second predetermined time is an estimated time, in which the vehicle moves from the outside of the communication range to an inside of the communication range.

13. The method according to claim 12,
wherein the executing the emergency notification process includes communicating by the center device with a preliminary registered emergency contact place when the center device fails to connect to the in-vehicle emergency notification device after the center device tries to connect the communication line to the in-vehicle emergency notification device in a case where the second predetermined time has elapsed since the center device determines that the vehicle is disposed outside the communication range of the communication network.

14. The method according to claim 12,
wherein the executing the emergency notification process includes communicating by the center device with a preliminary registered emergency contact place when the center device determines that the vehicle is disposed outside the communication range of the communication network.
